(19) United States
(12) Patent Application Publication
(10) Pub. No.: US 2016/0124265 A1
(43) Pub. Date: May 5, 2016

(54) POLARIZER, METHOD FOR MANUFACTURING POLARIZER AND DISPLAY PANEL

(71) Applicant: Samsung Display Co., Ltd., Yongin-si (KR)

(72) Inventors: Sang-Wook Lee, Yongin-si (KR); Chang-Ok Kim, Yongin-si (KR); Jun-Mo Im, Seoul (KR)

(21) Appl. No.: 14/875,208

(22) Filed: Oct. 5, 2015

(30) Foreign Application Priority Data
Oct. 30, 2014 (KR) 10-2014-0149450

(51) Int. Cl. G02F 1/1335; G02F 1/1368; C25D 11/02; C23F 1/02; C25D 11/04; G02B 5/30; G02F 1/1362

(52) U.S. Cl. CPC G02F 1/133528; G02B 5/3058; G02F 1/1368; G02F 1/136209; C23F 1/02; C25D 11/045; C25D 11/022; G02F 2001/133548

(57) ABSTRACT

A polarizer includes a base substrate and a wire grid array disposed on the base substrate. The wire grid array includes a plurality of linear patterns that extend in a first direction and are spaced apart from each other in a second direction crossing the first direction. The linear patterns include a metal layer and a metal oxide layer including an oxide of a metal included in the metal layer.

### CROSS-REFERENCE TO RELATED APPLICATIONS

This application claims priority from and the benefit of Korean Patent Application No. 10-2014-0149450, filed on Oct. 30, 2014, which is hereby incorporated by reference for all purposes as if fully set forth herein.

### BACKGROUND

1. Field

Exemplary embodiments relate to a polarizer. More particularly, exemplary embodiments relate to a wire grid polarizer that may be used for a liquid crystal display device, a method for manufacturing the polarizer and a display panel including the polarizer.

2. Discussion of the Background

A liquid crystal display device applies a voltage to a liquid crystal layer to change alignment of liquid crystal molecules. When alignment of liquid crystal molecules is changed, optical properties such as birefringence, dichroism, light scattering, or other optical activity causes visible change in the display of an image.

A liquid crystal display device generally includes a polarizer for controlling the transmittance of light. The polarizer may allow transmission of light waves parallel to a transmitting axis, and may absorb or reflect light waves perpendicular to the transmitting axis.

Examples of the polarizer may include an absorbing polarizer and a reflective polarizer. The reflective polarizer reflects a specific polarizing component for polarization. The reflective polarizing component may be reused by a reflective plate of a backlight assembly to increase the brightness of a display device. Furthermore, the reflective polarizer may be formed as a wire grid polarizer that is directly formed with a display panel to form an in-cell structure.

The wire grid polarizer includes a linear metal pattern. In order to form the linear metal pattern, a mask may be formed on a metal layer through a photolithography process, a nano-imprinting process, or the like, and the metal layer etched by said process. Furthermore, a hard mask including silicon oxide or the like may be formed though plasma enhanced chemical vapor deposition (PECVD) to prevent a profile of the metal pattern from being damaged when the metal layer is etched to form the metal pattern. However, when the PECVD is performed on a continuous metal layer which is not patterned, arc discharge may occur between the metal layer and a deposition device.

The above information disclosed in this Background section is only for enhancement of understanding of the background of the inventive concept, and, therefore, it may contain information that does not form the prior art that is already known in this country to a person of ordinary skill in the art.

### SUMMARY

Exemplary embodiments provide a polarizer that may be manufactured without the PECVD process, which may cause arc discharge.

Exemplary embodiments also provide a method for manufacturing the polarizer.

Exemplary embodiments also provide a display panel including the polarizer.

Additional aspects will be set forth in the detailed description which follows, and, in part, will be apparent from the disclosure, or may be learned by practice of the inventive concept.

According to an exemplary embodiment, a polarizer includes a base substrate and a wire grid array disposed on the base substrate. The wire grid array includes a plurality of linear patterns that extend in a first direction and are spaced apart from each other in a second direction crossing the first direction. The linear patterns include a metal layer and a metal oxide layer, with an oxide of a metal included in the metal layer.

According to another exemplary embodiment, a method for manufacturing a polarizer is provided. According to the method, a metal layer is formed on a base substrate. A mask pattern having a wire grid array shape is formed on the metal layer. An exposed upper portion of the metal layer is oxidized to form a metal oxide patter. The mask pattern is removed. The metal layer is patterned by using the metal oxide pattern as a mask to form a wire grid array including a plurality of linear patterns.

According to yet another exemplary embodiment, a display panel includes a first substrate including a first wire grid array, a second substrate facing the first substrate and a liquid crystal layer disposed between the first substrate and the second substrate. The first wire grid array includes a plurality of linear patterns extending in a first direction and spaced apart from each other in a second direction crossing the first direction. The linear patterns include a metal layer and a metal oxide layer including an oxide of a metal included in the metal layer.

The foregoing general description and the following detailed description are exemplary and explanatory and are intended to provide further explanation of the claimed subject matter.

### BRIEF DESCRIPTION OF THE DRAWINGS

The accompanying drawings, which are included to provide a further understanding of the inventive concept, and are incorporated in and constitute a part of this specification, illustrate exemplary embodiments of the inventive concept, and, together with the description, serve to explain principles of the inventive concept.

FIGS. 1, 2, 3, 4, 5, and 6 are cross-sectional views illustrating a method for manufacturing a polarizer according to an exemplary embodiment.

FIG. 7 is a plan view illustrating a polarizer according to an exemplary embodiment.

FIGS. 8, 9, 10, and 11 are cross-sectional views illustrating a method for manufacturing a polarizer according to an exemplary embodiment.

FIG. 12 is a plan view illustrating a polarizer according to an exemplary embodiment.

FIGS. 13 and 14 are cross-sectional views illustrating display panels according to exemplary embodiments.

### DETAILED DESCRIPTION OF THE ILLUSTRATED EMBODIMENTS

In the following description, for the purposes of explanation, numerous specific details are set forth in order to provide a thorough understanding of various exemplary embodiments. It is apparent, however, that various exemplary embodiments may be practiced without these specific details or with one or more equivalent arrangements. In other instances, well-known structures and devices are shown in block diagram form in order to avoid unnecessarily obscuring various exemplary embodiments.

In the accompanying figures, the size and relative sizes of layers, films, panels, regions, etc., may be exaggerated for clarity and descriptive purposes. Also, like reference numerals denote like elements.

When an element or layer is referred to as being “on,” “connected to,” or “coupled to” another element or layer, it may be directly on, connected to, or coupled to the other element or layer or intervening elements or layers may be present. When, however, an element or layer is referred to as being “directly on,” “directly connected to,” or “directly coupled to” another element or layer, there are no intervening elements or layers present. For the purposes of this disclosure, “at least one of X, Y, and Z” and “at least one selected from the group consisting of X, Y, and Z” may be construed as X only, Y only, Z only, or any combination of two or more of X, Y, and Z, such as, for instance, XYZ, XYY, YZ, and ZZ. Like numbers refer to like elements throughout. As used herein, the term “and/or” includes any and all combinations of one or more of the associated listed items.

Although the terms first, second, etc. may be used herein to describe various elements, components, regions, layers, and/or sections, these elements, components, regions, layers, and/or sections should not be limited by these terms. These terms are used to distinguish one element, component, region, layer, and/or section from another element, component, region, layer, and/or section. Thus, a first element, component, region, layer, and/or section discussed below could be termed a second element, component, region, layer, and/or section without departing from the teachings of the present disclosure.

Spatially relative terms, such as “beneath,” “below,” “lower,” “above,” “upper,” and the like, may be used herein for descriptive purposes, and, thereby, to describe one element or feature's relationship to another element(s) or feature(s) as illustrated in the drawings. Spatially relative terms are intended to encompass different orientations of an apparatus in use, operation, and/or manufacture in addition to the orientation depicted in the drawings. For example, if the apparatus in the drawings is turned over, elements described as “below” or “beneath” other elements or features would then be oriented “above” the other elements or features. Thus, the exemplary term “below” can encompass both an orientation of above and below. Furthermore, the apparatus may be otherwise oriented (e.g., rotated 90 degrees or at other orientations), and, as such, the spatially relative descriptors used herein interpreted accordingly.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises,” “comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof.

Various exemplary embodiments are described herein with reference to sectional illustrations that are schematic illustrations of idealized exemplary embodiments and/or intermediate structures. As such, variations from the shapes of the illustrations as a result, for example, of manufacturing techniques and/or tolerances, are to be expected. Thus, exemplary embodiments disclosed herein should not be construed as limited to the particular illustrated shapes of regions, but are to include deviations in shapes that result from, for instance, manufacturing. As such, the regions illustrated in the drawings are schematic in nature and their shapes are not intended to illustrate the actual shape of a region of a device and are not intended to be limiting.

Unless otherwise defined, all terms (including technical and scientific terms) used herein have the same meaning as commonly understood by one of ordinary skill in the art to which this disclosure is a part. Terms, such as those defined in commonly used dictionaries, should be interpreted as having a meaning that is consistent with their meaning in the context of the relevant art and will not be interpreted in an idealized or overly formal sense, unless expressly so defined herein.

A polarizer, a method for manufacturing the polarizer, and a display panel including the polarizer according to exemplary embodiments will be described more fully hereinafter with reference to the accompanying drawings, in which various embodiments are shown.

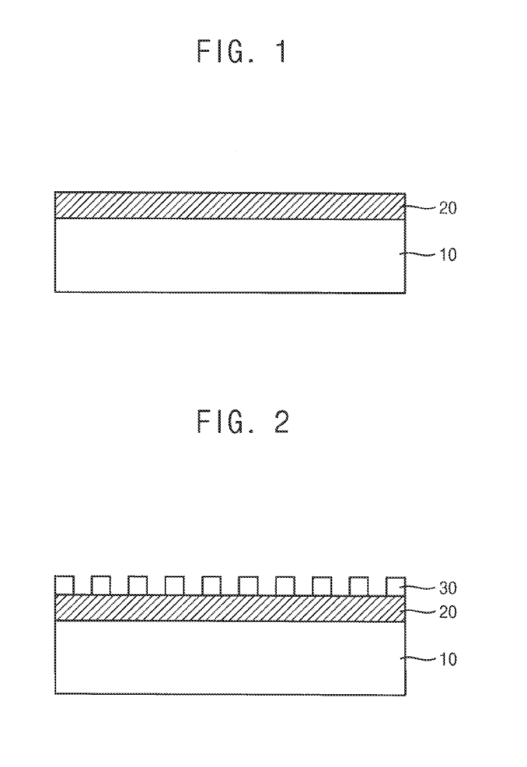

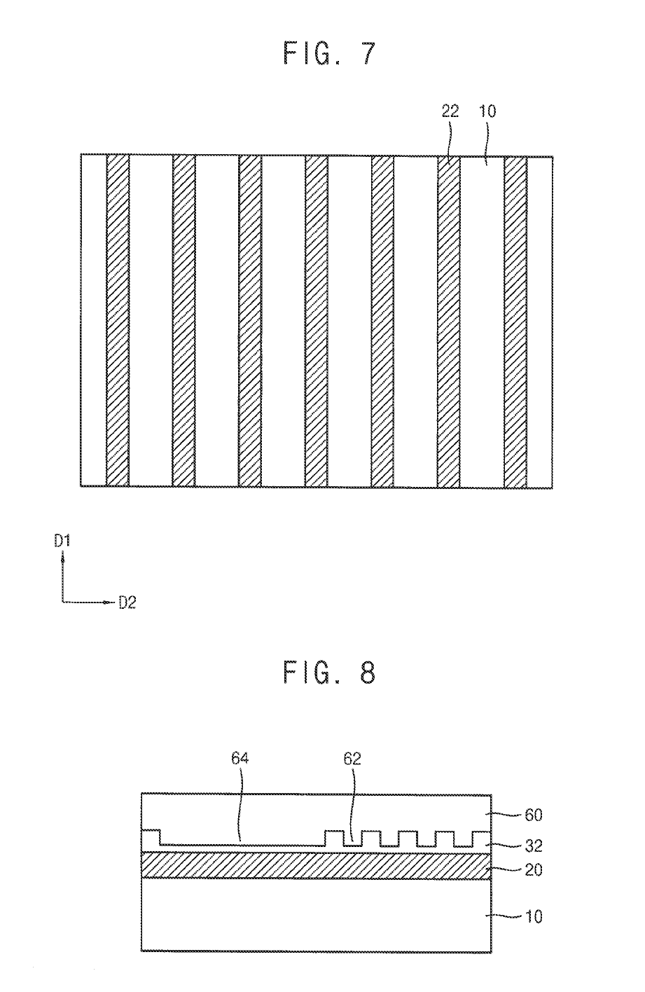

FIGS. 1 to 6 are cross-sectional views illustrating a method for manufacturing a polarizer according to an exemplary embodiment. FIG. 7 is a plan view illustrating a polarizer according to an exemplary embodiment.

Referring to FIG. 1, a metal layer 20 is formed on a base substrate 10.

Examples of the base substrate 10 may include a glass substrate, a quartz substrate, a sapphire substrate, a plastic substrate, or the like. The plastic substrate may include polyimide, polyethylene terephthalate, polyethylene naphthalate, polyvinyl chloride, or the like.

The metal layer 20 may include aluminum, gold, silver, copper, chromium, iron, nickel, titanium, molybdenum, tungsten or an alloy thereof. According to one or more exemplary embodiments, the metal layer 20 may include aluminum. It is contemplated, however, that any other suitable material may be utilized in association with exemplary embodiments described herein.

The metal layer 20 may have a single-layered structure, or a multi-layered structure including different materials. According to one or more exemplary embodiments, when the metal layer 20 has multiple layers, the upper layer, of which the upper surface is exposed may include aluminum. It is contemplated, however, that any other suitable material may be utilized in association with exemplary embodiments described herein.

Referring to FIG. 2, a mask pattern 30 having a wire grid shape is formed on the metal layer 20. The mask pattern 30 may include a polymer resin. The mask pattern 30 may be formed through a photolithograph process, a nano-imprinting process, or the like. As a result, an upper surface of the metal layer 20 may be partially exposed.

In an exemplary embodiment, a photoresist composition may be coated on the metal layer 20 to form a coating layer, and the coating layer may be partially exposed to a light through a mask and developed to form the mask pattern 30.

In another embodiment, a photo-curable composition may be coated on the metal layer 20 to form a coating layer, and the coating layer may be pressed by a mold having a protrusion surface corresponding to a shape of the mask pattern 30. The pressed coating layer may be cured, and the mold may be removed. After the mold is removed, an etching process or the like may be further performed to expose an upper surface of the metal layer 20.

The mask pattern 30 includes a plurality of linear patterns that extend in a first direction, and are spaced apart from each other in a second direction crossing the first direction. The mask pattern 30 may have a shape substantially the same as the wire grid metal pattern manufactured by the present embodiment.

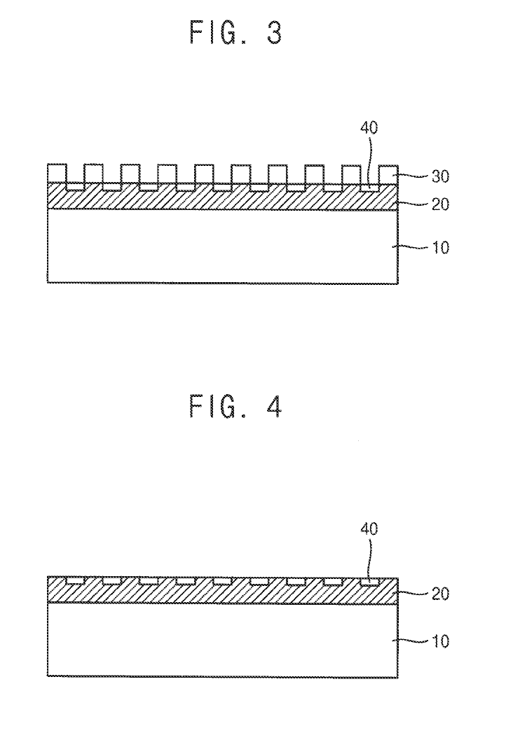

Referring to FIG. 3, an exposed portion of the metal layer 20 is oxidized to form a metal oxide pattern 40. The metal oxide pattern 40 may be formed through anodizing. Since a shape of the metal oxide pattern 40 is defined by the mask pattern 30, the metal oxide pattern 40 may have a wire grid array shape substantially same as the mask pattern 30.

Examples of anodizing may include a direct current method, a sulfuric acid method, a plasma electrolytic oxidation method, and the like.

For example, if the metal layer 20 includes aluminum, when an electric current is applied to the metal layer 20 via a cathode in an electrolyte, oxygen in the electrolyte reacts with aluminum of the metal layer 20 to form aluminum oxide (Al₂O₃) at the surface of the metal layer 20.

For example, the electrolyte may include water, sulfuric acid, phosphoric acid, nitric acid, nitrate, sulfate, phosphate, or the like.

Referring to FIG. 4, the mask pattern 30 may be removed through an etching process or by a stripper. As a result, the upper surface of the metal layer 20 is partially exposed.

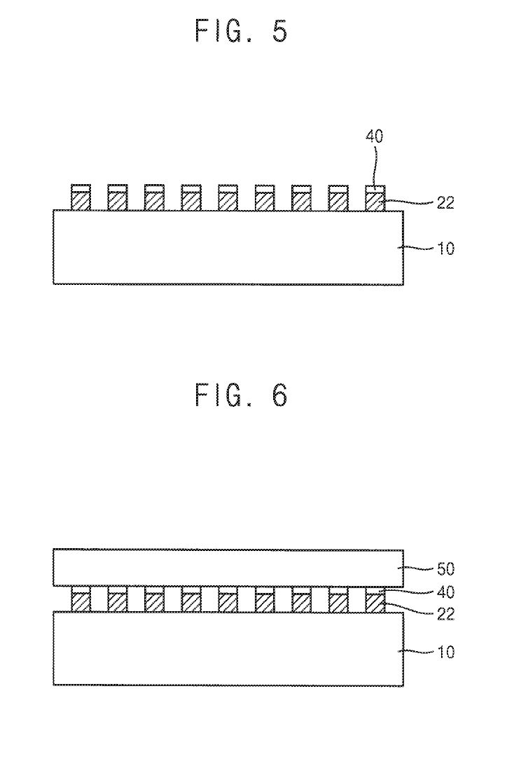

Referring to FIG. 5, the metal layer 20 is patterned by using the metal oxide pattern 40 as a mask. For example, the metal layer 20 may be patterned through a dry-etching process. For example, when the metal layer 20 includes aluminum, a chlorine-containing gas may be used for etching the metal layer 20. Because aluminum oxide is greatly resistant to etching by chlorine-containing gas, the portion of the metal layer 20 disposed under the metal oxide pattern 40 may remain while an exposed portion of the metal layer 20 is removed. The remaining portions of metal layer 20 form a wire grid metal pattern 22. Accordingly, a linear pattern including a metal layer and a metal oxide layer including an oxide of a metal included in the metal layer is formed.

The Moh's hardness of aluminum oxide is more than about 9, which is much greater than the Moh's hardness of aluminum, which is about 2.75. Thus, a selection ratio for mechanical etching may be obtained.

The wire grid metal pattern 22 includes a plurality of linear patterns spaced apart from each other. Referring to FIG. 7, the linear patterns extend in a first direction D1 and are spaced apart from each other in a second direction D2 substantially perpendicular to the first direction D1. The wire grid metal pattern 22 may have a pitch, a thickness and a line width that is appropriate for polarizing light.

The pitch of the linear patterns, which may be the sum of the width of the linear pattern and the gap between adjacent linear patterns, may be less than the wavelength of an incident light. For example, the pitch of the linear patterns may be equal to or less than about 400 nm for polarizing visible light. According to one or more exemplary embodiments, the pitch of the linear patterns may be equal to or less than about 150 nm. For example, the pitch of the linear patterns may be about 50 nm to about 150 nm. It is contemplated, however, that any other suitable pitch of the linear pattern may be utilized in association with exemplary embodiments described herein.

In an exemplary embodiment, the thickness of the linear pattern may be equal to or more than about 80 nm. According to one or more exemplary embodiments, the thickness of the linear pattern may be about 80 nm to about 300 nm. It is contemplated, however, that any other suitable thickness of the linear pattern may be utilized in association with exemplary embodiments described herein.

The transmittance or refractivity of the wire grid metal pattern 22 may depend on the ratio of the line width to the pitch. The line width of the linear pattern may be equal to or less than about 100 nm. For example, the line width may be about 20 nm to about 100 nm.

Referring to FIG. 6, a protective layer 50 is formed to cover the wire grid metal pattern 22.

The protective layer 50 may have the shape of a continuous film. The protective layer 50 protects the wire grid metal pattern 22. For example, the protective layer 50 may have a shape of a flat thin film to be spaced entirely apart from the base substrate 100. Thus, an air gap may be formed between adjacent linear patterns. The air gap may increase the refractivity difference of the polarizer to improve polarizing characteristics.

The protective layer 50 may include an inorganic insulating material such as a silicon oxide (SiOₓ), silicon oxicarbide (SiOC), a silicon nitride (SiNₓ), or the like, and may be formed through a chemical vapor deposition process. The thickness of the protective layer 50 may be about 100 nm to about 1 um.

While the polarizer includes the protective layer having a shape of a flat thin film such that an air gap is formed between adjacent linear patterns in the exemplary embodiment, a polarizer according to another exemplary embodiment may include an organic insulation layer or an inorganic insulation layer, which fills the gap between the linear patterns.

According to an exemplary embodiment, a hard mask including a metal oxide may be formed through anodizing a metal layer in the process of forming a wire grid polarizer. Thus, the plasma chemical vapor deposition process for forming a hard mask including silicon oxide or the like may be omitted. As such, deterioration of manufacturing reliability due to arc-discharging may be prevented.

FIGS. 8 to 11 are cross-sectional views illustrating a method for manufacturing a polarizer according to an exemplary embodiment. FIG. 12 is a plan view illustrating a polarizer according to an exemplary embodiment. Hereinafter, any explanation duplicated with the method for manufacturing a polarizer, which is illustrated in FIGS. 1 to 6, may be omitted, and the same reference numerals may be used for same components.

Referring to FIG. 8, a metal layer 20 is formed on a base substrate 10. A photo-curable composition is coated on the metal layer 20 to form a coating layer. The coating layer 32 is pressed by a mold 60 to transcribe a pattern of the contact surface of the mold 60 to the coating layer 32.

The contact surface of the mold 60 may includes a first protrusion 62 and a second protrusion 64. A plurality of first protrusions 62 are arranged to form a wire grid pattern. The second protrusion 64 has a width greater than a width of the first protrusion 62. As a shape of the contact surface of the mold 60 is transcribed to the coating layer 32, protrusions are formed at the coating layer 32. The mold may include a transparent material such as quartz. An ultraviolet ray may be irradiated to the coating layer through the mold 60 to cure the coating layer 32.

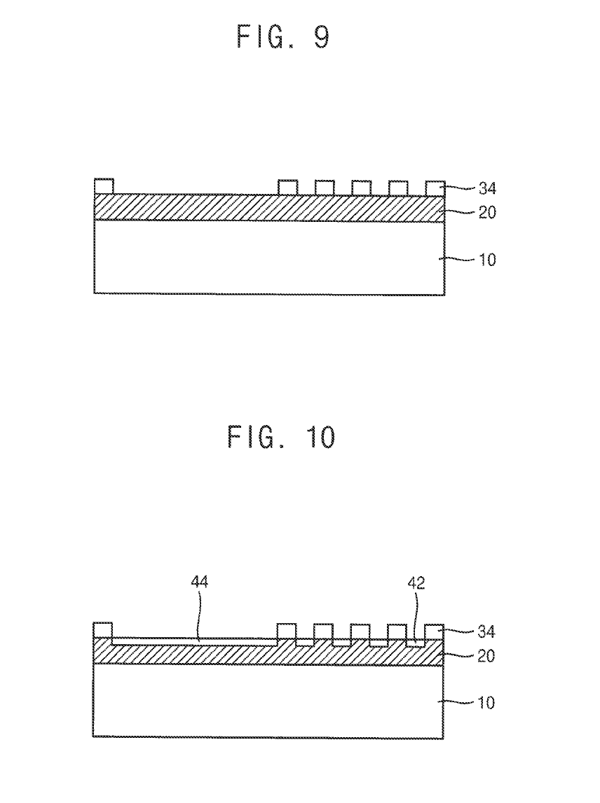

Referring to FIG. 9, after the mold 60 is separated from the coating layer 32, and the coating layer 32 is etched to form a mask pattern 34. The mask pattern 34 includes a plurality of linear patterns so that an upper surface of the metal layer 20 overlapping with a gap between adjacent linear patterns and the second protrusion 64 of the mold 60 is exposed.

Referring to FIG. 10, an exposed upper portion of the metal layer 20 is oxidized to form a metal oxide pattern. The metal oxide pattern may be formed through an anodizing method. The shape of the metal oxide pattern may depend on the shape of the mask pattern 34. Thus, the metal oxide pattern may include a first metal oxide pattern 42 having a wire grid array shape substantially the same as the mask pattern 34, and a second metal oxide pattern 44 corresponding an area where the mask pattern 34 is not disposed. The second metal oxide pattern 44 has a width greater than the width of the first metal oxide pattern 42.

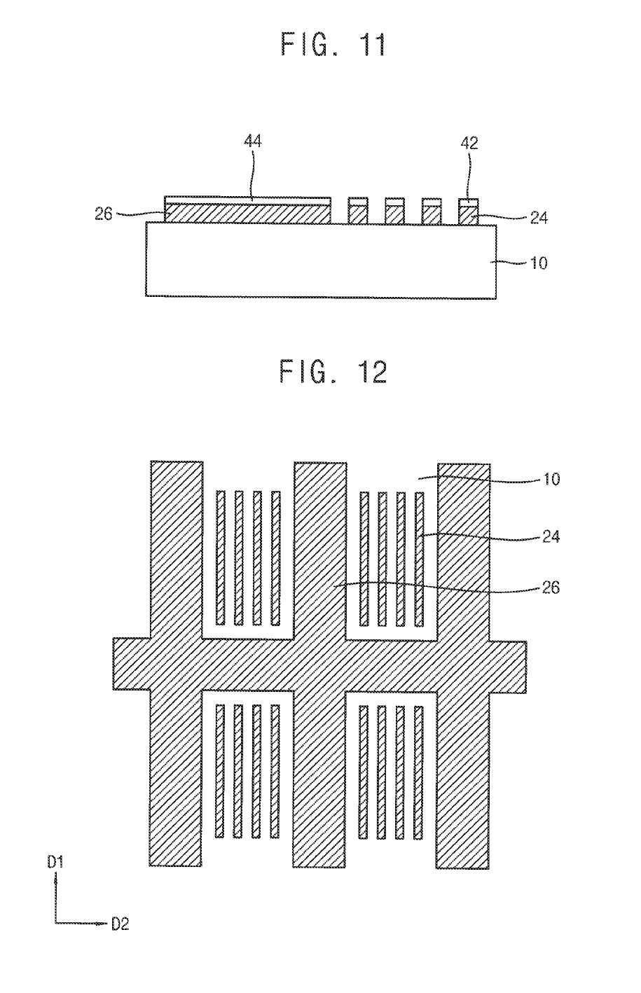

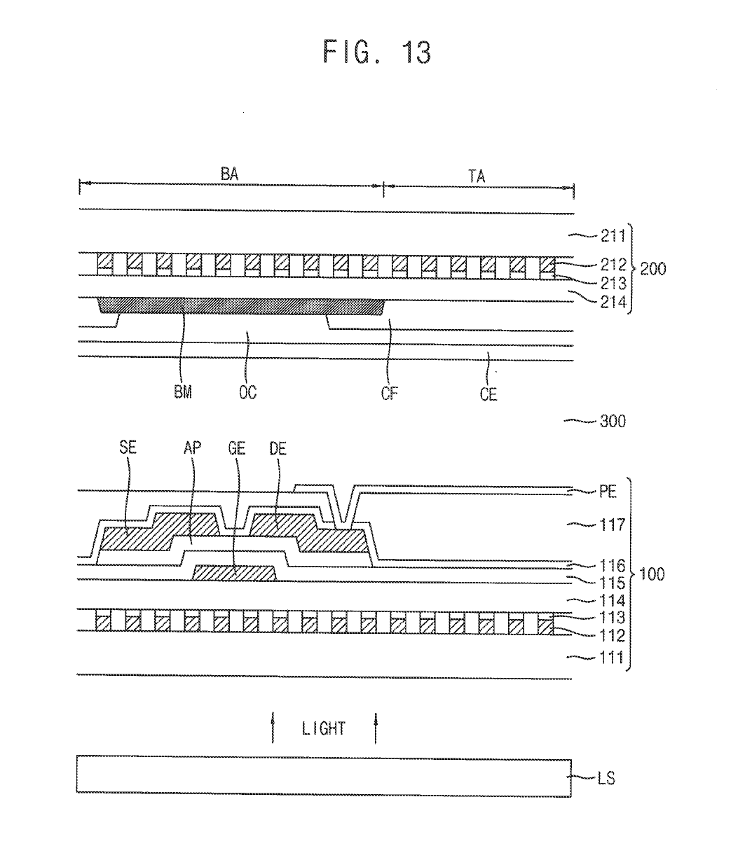

Referring to FIG. 11, after the mask pattern 34 is removed, the metal layer 20 is patterned by using the metal oxide pattern as a mask. Thus, a first metal pattern 24 overlapping with the first metal oxide pattern 42, and a second metal pattern 26 overlapping with the second metal oxide pattern 44 are formed.

Referring to FIG. 12, a plurality of first metal patterns 24 are arranged to form a wire grid array. The first metal patterns 24 extend in a first direction D1, and are spaced apart from each other in a second direction D2 substantially perpendicular to the first direction D1. The second metal pattern 26 has a width greater than a width of the first metal pattern 24. The second metal pattern 26 may extend in the first direction D1 and in the second direction D2 to have a matrix shape. The first metal patterns 24 may correspond to a polarizing part, and the second metal pattern 26 may correspond to a light-blocking pattern.

The second metal pattern 26 may reflect a light incident thereon. Thus, the polarizer including the second metal pattern 26 may be employed in a display panel for increasing reuse of a light or for achieving mirror display.

In an exemplary embodiment, the first metal pattern 24 and the second metal pattern 26 are formed from a same metal layer. However, exemplary embodiments are not limited thereto. For example, a black matrix including carbon black or the like may be formed through an additional process instead of forming the second metal pattern 26.

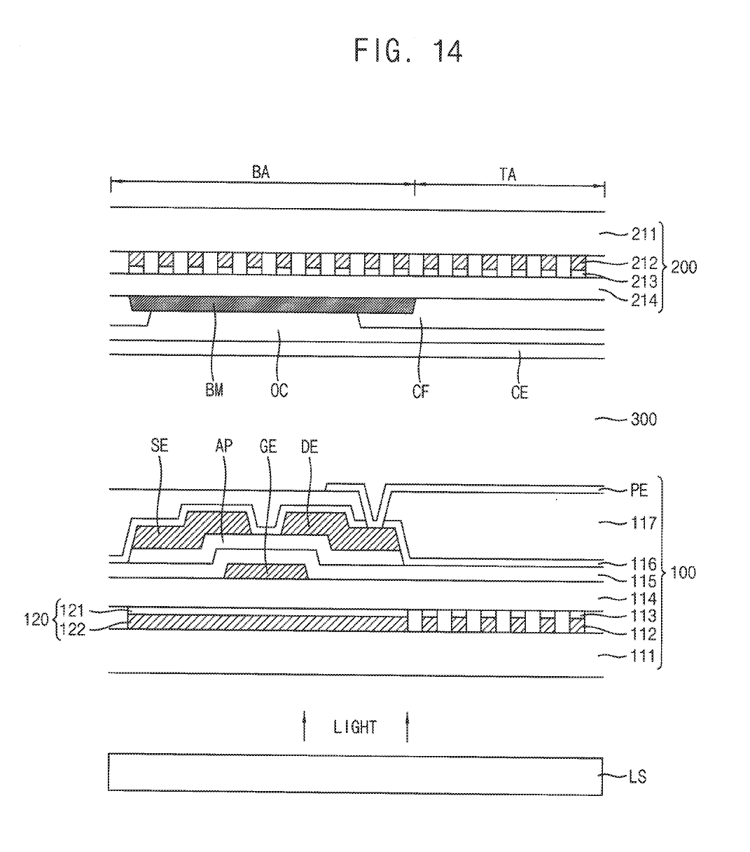

FIGS. 13 and 14 are cross-sectional views illustrating display panels according to exemplary embodiments.

Referring to FIG. 13, a display panel includes a first substrate 100, a second substrate 200 facing the first substrate 100, and a liquid crystal layer 300 interposed between the first and second substrates 100 and 200. The display panel receives a light LIGHT from a light source module LS disposed under the display panel to display an image.

The first substrate 100 includes a first polarizer and a thin film transistor array. A light incident on the first polarizer from the light source module LS is partially transmitted, and the rest of the light is reflected. The reflected light enters the light source module LS, and is reflected again by a reflective member of the light source module LS to enter the display panel.

The first substrate 100 includes a first base substrate 111, a first wire grid array, a protective layer 114, a gate electrode GE, a gate insulation layer 115, an active pattern AP, a source electrode SE, a drain electrode DE, a passivation layer 116, an organic insulation layer 117 and a pixel electrode PE. The first wire grid array includes a plurality of linear patterns spaced apart from each other.

Each of the linear patterns of the first wire grid array includes a metal layer 112 and a metal oxide layer 113. The metal oxide layer 113 includes an oxide of a metal included in the metal layer 112. The linear patterns polarize a light incident thereon. The metal oxide layer 113 covers the metal layer 112 and functions as a hard mask in the process of forming the linear patterns. The protective layer 114 is disposed on the metal oxide layer 113.

The first polarizer including the first wire grid array is substantially the same as the polarizer previously explained above. Thus, any duplicated explanation may be omitted.

The gate electrode GE, the active pattern AP, the source electrode SE and the drain electrode DE form a thin film transistor. The thin film transistor is electrically connected to the pixel electrode PE. The thin film transistor is disposed between the first polarizer and the first base substrate 111. The thin film transistor array may be formed on the first polarizer after the first polarizer is formed on the first base substrate 111.

The gate electrode GE is disposed on the protective layer 114. The gate electrode GE is electrically connected to a gate line that extends in a direction on the first base substrate 111. The gate electrode GE may include aluminum, copper, chrome, molybdenum, tungsten, titanium, gold, silver, nickel or an alloy thereof. Furthermore, the gate electrode GE may have a single-layered structure or a multi-layered structure including metal layers different from each other. For example, the gate electrode GE may have a triple-layered structure of aluminum/molybdenum/aluminum or a double-layered structure including an upper layer of copper, and a lower layer of titanium.

The gate insulation layer 115 covers the gate electrode GE. The gate insulation layer 115 may include an inorganic insulation material such as silicon oxide, silicon nitride or the like. The gate insulation layer 115 may have a single-layered structure or a multiple-layered structure including a plurality of layers including different materials. For example, the gate insulation layer 115 may include an upper layer including silicon oxide and a lower layer including silicon nitride.

The active pattern AP is disposed on the gate insulation layer 115, and overlaps with the gate electrode GE. The active pattern AP forms a channel between the source electrode SE and the drain electrode DE. The active pattern AP may include amorphous silicon, polysilicon, an oxide semiconductor or the like. When the active pattern AP includes amorphous silicon, the active pattern AP may further include an ohmic contact layer contacting the source electrode SE and the drain electrode DE. The oxide semiconductor may include a multicomponent metal oxide such as indium gallium oxide, indium gallium zinc oxide or the like.

The source electrode SE is electrically connected to a data line. The data line, the source electrode SE and the drain electrode DE may be formed from a same metal layer. The source electrode SE may include aluminum, copper, chrome, molybdenum, tungsten, titanium, gold, silver, nickel or an alloy thereof. Furthermore, the source electrode SE may have a single-layered structure or a multi-layered structure including metal layers different from each other. For example, the source electrode SE may have a triple-layered structure of aluminum/molybdenum/aluminum or a double-layered structure including an upper layer of copper, and a lower layer of titanium. In another embodiment, the source electrode SE may include a barrier layer including a metal oxide. For example, the source electrode SE may include a copper layer and a metal oxide layer disposed on or under the copper layer. The metal oxide layer may include indium zinc oxide, indium gallium oxide, gallium zinc oxide or the like.

The passivation layer 116 covers the source electrode SE, the drain electrode DE and the gate insulation layer 115. The passivation layer 116 may include an inorganic insulation material such as silicon oxide, silicon nitride or the like.

The organic insulation layer 117 is disposed on the passivation layer 116 to flatten the substrate. The organic insulation layer 117 may include an organic insulation material such as an acryl resin, a phenol resin or the like. In another embodiment, the passivation layer 116 or the organic insulation layer 117 may be omitted.

The pixel electrode PE is disposed on the organic insulation layer 117. The pixel electrode PE is electrically connected to the drain electrode DE. A pixel voltage is applied to the pixel electrode PE through the thin film transistor so that an electric field is formed by a voltage difference between the pixel voltage and a common voltage applied to a common electrode.

In an embodiment, the pixel electrode PE passes through the passivation layer 116 and the organic insulation layer 117 to contact the drain electrode DE. The pixel electrode PE may include a transparent conductive material such as indium tin oxide, indium zinc oxide or the like.

The second substrate 200 includes a second polarizer. Particularly, the second substrate 200 includes a second base substrate 211, a second wire grid array, a protective layer 214, a light-blocking member BM, a color filter CF, an overcoating layer OC and a common electrode CE. The second wire grid array includes a plurality of linear patterns spaced apart from each other.

Each of the linear patterns of the second wire grid array includes a metal layer 212 and a metal oxide layer 213. The metal oxide layer 213 includes oxide of a metal included in the metal layer 212. The second polarizer including the second wire grid array may be substantially the same as the first polarizer except for being vertically inversed. Thus, any duplicated explanation may be omitted.

While the linear patterns of the second wire grid array extend in the same direction as the linear patterns of the first wire grid array in an embodiment, the linear patterns of the second wire grid array may extend in a different direction from the linear patterns of the first wire grid array. For example, the linear patterns of the second wire grid array may extend in a direction perpendicular to the linear patterns of the first wire grid array.

The light-blocking member BM is disposed on the protective layer 214. The light-blocking member BM may be a black matrix having a matrix configuration including a binder resin and a black coloring agent. The light-blocking member BM may overlap with the thin film transistor. For example, an area overlapping with the light-blocking member BM may be defined as a light-blocking area BA and the remaining area may be defined as a light-transmitting area TA.

The color filter CF is disposed on the protective layer 214. The color filter CF faces the pixel electrode PE. The color filter CF may include a red filter, a green filter, a blue filter, a cyan filter, a yellow filter, a magenta filter, a white filter or the like.

The overcoating layer OC covers the light-blocking member BM and the color filter CF. The overcoating layer OC may include an organic insulation material.

The common electrode CE is disposed on the overcoating layer OC and overlaps with the pixel electrode PE. The common electrode CE may include a transparent conductive material such as indium tin oxide, indium zinc oxide or the like.

Even though not illustrated, each of the first substrate 100 and the second substrate 200 may further include an alignment layer contacting the liquid crystal layer 300.

In an exemplary embodiment, the pixel electrode PE is disposed in the first substrate 100, and the common electrode CE is disposed in the second substrate 200. However, in another exemplary embodiment, a pixel electrode and a common electrode may be disposed in a same substrate. Furthermore, in another exemplary embodiment, a color filter and/or a light-blocking member may be disposed in a thin film transistor substrate.

Referring to FIG. 14, a display panel includes a first substrate 100, a second substrate 200 facing the first substrate 100, and a liquid crystal layer 400 interposed between the first and second substrates 100 and 200. The display panel is substantially same as the display panel illustrated in FIG. 13 except that the first substrate 100 further includes a light-blocking pattern 120 disposed in a same layer as a wire grid array. Thus, any duplicated explanation may be omitted, and same reference numerals may be used for equivalent components.

The first substrate 100 includes a light-blocking pattern 120 disposed between a first base substrate 111 and a protective layer 114. The light-blocking pattern 120 includes a metal layer 122 and a metal oxide layer 121. The metal layer 122 is formed from a same layer as a metal layer 112 of a linear pattern of a first wire grid array. The metal oxide layer 121 is formed from a same layer as a metal oxide layer 113 of the linear pattern of the first wire grid array. The light-blocking pattern 120 has a width greater than the linear pattern of the first wire grid array. The light-blocking pattern 120 may overlap with a thin film transistor. Furthermore, the light-blocking pattern may have a matrix shape to overlap with a light-blocking member BM of the second substrate 200.

The light-blocking pattern 120 entirely reflects a light incident thereon. A reflected light is reflected again by a reflective member of a light source module to be reused. Thus, a brightness of the display panel may be improved.

In the above embodiments, the first polarizer including the first wire grid array is disposed on an upper surface of the first base substrate. However, in another embodiment, the first polarizer may be disposed on a lower surface of the first base substrate. Furthermore, the second polarizer including the second wire grid array may be disposed on an upper surface of the second base substrate in another embodiment.

The present inventive concept has been explained with a liquid crystal display panel, however, is not limited thereto. For example, an exemplary embodiment may be employed in various display devices such as an organic light-emitting device or other optical devices which may include a polarizer.

According to the exemplary embodiments, a hard mask including a metal oxide may be formed through anodizing a metal layer during the process of forming a wire grid polarizer. Thus, a plasma chemical vapor deposition process for forming a hard mask including silicon oxide or the like may be omitted, and deterioration of manufacturing reliability due to arc-discharging may be prevented.

Although certain exemplary embodiments and implementations have been described herein, other embodiments and modifications will be apparent from this description. Accordingly, the inventive concept is not limited to such embodiments, but rather to the broader scope of the presented claims and various obvious modifications and equivalent arrangements.

What is claimed is:

1. A polarizer comprising:
a base substrate; and
a wire grid array disposed on the base substrate and including a plurality of linear patterns that extend in a first direction and are spaced apart from each other in a second direction crossing the first direction, the linear patterns comprising a metal layer and a metal oxide layer including an oxide of a metal included in the metal layer.

2. The polarizer of claim 1, wherein the metal layer comprises aluminum.

3. The polarizer of claim 2, wherein the metal oxide layer comprises aluminum oxide (Al₂O₃).

4. The polarizer of claim 1, wherein a width of the linear patterns is between 20 nm and 100 nm.

5. The polarizer of claim 4, wherein a pitch of the linear patterns is between 50 nm and 150 nm.

6. The polarizer of claim 1, further comprising a protective layer configured to cover the wire grid array and comprising at least one material selected from the group consisting of silicon oxide, silicon oxicarbide, and silicon nitride.

7. A method for manufacturing a polarizer, comprising:
disposing a metal layer on a base substrate;
disposing a mask pattern having a wire grid array shape on the metal layer;
oxidizing an exposed upper portion of the metal layer to form a metal oxide pattern;
removing the mask pattern; and
patterning the metal layer by using the metal oxide pattern as a mask to form a wire grid array including a plurality of linear patterns.

8. The method of claim 7, wherein the metal layer comprises aluminum.

9. The method of claim 8, wherein the exposed upper portion of the metal layer is oxidized through an anodizing method.

10. The method of claim 7, wherein the metal layer is patterned through a dry-etching method.

11. The method of claim 7, wherein a width of the linear patterns is between 20 nm and 100 nm.

12. The method of claim 11, wherein a pitch of the linear patterns is between 50 nm and 150 nm.

13. The method of claim 7, further comprising:
disposing a protective layer configured to cover the wire grid array, the protective layer comprising at least one material selected from the group consisting of silicon oxide, silicon oxicarbide, and silicon nitride.

14. A display panel comprising:
a first substrate comprising a first wire grid array comprising a plurality of linear patterns, the linear patterns extending in a first direction and spaced apart from each other in a second direction crossing the first direction, the linear patterns comprising a metal layer and a metal oxide layer including an oxide of a metal included in the metal layer;
a second substrate disposed facing the first substrate; and
a liquid crystal layer disposed between the first substrate and the second substrate.

15. The display panel of claim 14, wherein the metal layer comprises aluminum.

16. The display panel of claim 15, wherein the metal oxide layer comprises aluminum oxide (Al₂O₃).

17. The display panel of claim 14, wherein the first substrate further comprises a thin film transistor disposed in a layer different from the first wire grid array, and a pixel electrode electrically connected to the thin film transistor.

18. The display panel of claim 17, wherein the first substrate further comprises a light-blocking pattern disposed in a same layer as the first wire grid array and including a same material as the linear patterns and having a width greater than the linear pattern.

19. The display panel of claim 18, wherein the light-blocking pattern is configured to overlap with the thin film transistor.

20. The display panel of claim 14, wherein the second substrate comprises a second wire grid array comprising a plurality of linear patterns spaced apart from each other, the linear patterns of the second wire grid array comprising a metal layer and a metal oxide layer including an oxide of a metal included in the metal layer.
